(19) United States
(12) Patent Application Publication
(10) Pub. No.: US 2020/0342532 A1
(43) Pub. Date: Oct. 29, 2020

(54) SYSTEMS AND METHODS FOR BUNCHED ORDER PROCESSING

(71) Applicant: Perfectna, Inc., Carlsbad, CA (US)

(72) Inventor: Daniel G. Pena, San Diego, CA (US)

(21) Appl. No.: 16/860,031

(22) Filed: Apr. 27, 2020

Related U.S. Application Data
(60) Provisional application No. 62/839,113, filed on Apr. 26, 2019.

(51) Int. Cl. G06Q 40/04; G06Q 50/26; G06F 16/25

(52) U.S. Cl. CPC G06Q 40/04; G06F 16/252; G06Q 50/265

(57) ABSTRACT

The presently disclosed systems and methods for bunched orders allow individual trading accounts to be run through pre-trade risk checks while being sent to an exchange from a single bunched order.

### CROSS-REFERENCE TO RELATED APPLICATIONS

This Application claims the benefit of U.S. Provisional Application Ser. No. 62/839,113, filed on 26 Apr. 2019, the entire contents and substance of which is incorporated herein by reference in its entirety as if fully set forth below.

### FIELD OF THE DISCLOSURE

The present disclosure relates generally to systems and methods for trading. Particularly, embodiments of the present disclosure relate to systems and methods of bunched order processing where bunched orders constitute improved block orders wherein all individual sub-accounts in the block order have undergone required pre-trade risk assessments.

### BACKGROUND

A bunched order is a trade order placed by a single trader on behalf of multiple sub accounts linked with the single trader. The bunched order can be sent to an exchange in a single order with multiple sub accounts included. Currently, block orders are placed without pre-trade risk checks on the linked individual accounts. Therefore, there is risk that one of the individual sub-accounts within the block order does not have the necessary capital or margin to complete the order. This would leave it to the broker to cover the trade, exposing the broker to significant debit risk.

Similarly, give-up is a process that allows an executing broker to place trades on behalf of a client at a second broker (i.e., clearing broker). Give-up often is used by money managers who have clients at multiple brokers. Give-up orders take on even greater risk for both executing and clearing brokers. For example, money manager has an account at Broker A (executing broker). Money manager has a client with a trading account held at Broker B (clearing broker). Money manager places trades on behalf of their client in a block order, executing the trade through Broker A. At the end of the day, the money manager will send Broker A the appropriate allocations for the client. Broker A will then “give-up” the appropriate orders/allocations to Broker B (clearing broker).

Again, a problem in this scenario is that there are no pre-trade risk checks on the client account at broker B. There is a very real possibility that the money manager can place trades on behalf of their client where the client's account does not have funds to complete the trade, or other risk parameters. In addition, Broker B (clearing broker) is blind to their clients' trading activity all day until Broker A (executing broker) “gives-up” the day's orders. Broker B is completely unaware of the trading activity occurring on behalf of their client's account until the end of the day.

In a typical give-up agreement, there are limits to the number of contracts any client account can be traded. But enforcement of these limits is completely reliant on the money manager or trader adhering to those limits absent any systematic checks in place. Mistakes can be made whether intentional or unintentional. Many brokers do not allow give-up orders at all due to this inherent risk. A large futures FCM (brokerage) lost $26M in February of 2018 due to this risk.

The National Futures Association (“NFA”), the regulatory body for the futures industry, requires that individual sub-accounts in a block order must run through pre-trade risk before being sent to exchange. As described above, despite the requirement, such pre-trade risk assessments currently are not being done. As an example, all managed futures trades are placed as block orders and thus all managed futures trades currently are in violation of the law. Managed futures is a massive portion of the futures industry traded volume. And since there is no technology in place to monitor compliance to this rule, the NFA is not enforcing it.

What is needed, therefore, is an improved solution to block order processing. Embodiments of the present disclosure address this need as well as other needs that will become apparent upon reading the description below in conjunction with the drawings.

### SUMMARY

The present disclosure relates generally to systems and methods for trading. Particularly, embodiments of the present disclosure relate to systems and methods of bunched order processing. Embodiments of the present disclosure can provide technology to solve the aforementioned issues and run all individual sub-accounts through pre-trade risk assessments by moving away from the conventional block order method, and into the bunched order method. In some embodiments, the system connects the lead trader's messenger account to all sub-accounts via an order router's back office. The lead trader, investor, or broker can create pre-determined allocations based on ratios, percentages, multiples, or a finite number. When the lead trader places a trade in their Messenger account, the system can create a new bunched order with all sub-accounts connected to that lead trader's order details. In some embodiments, the system can create the allocations based on the lead trader's preset parameters. In other embodiments still, the system can then send the bunched order to the order router who performs pre-trade risk checks based off of the allocations.

### BRIEF DESCRIPTION OF THE DRAWINGS

The accompanying drawings, which are incorporated in and constitute a part of this specification, illustrate multiple embodiments of the presently disclosed subject matter and serve to explain the principles of the presently disclosed subject matter. The drawings are not intended to limit the scope of the presently disclosed subject matter in any manner.

FIG. 1 illustrates a system for executing block bunched orders according to some implementations of the present disclosure.

FIG. 2 is a flowchart of a method for executing block bunched orders according to some implementations of the present disclosure.

FIG. 3 is a timing diagram for executing block bunched order processing according to some implementations of the present disclosure.

FIG. 4 is a component diagram illustrating a bunched order system according to some implementations of the present disclosure.

### DETAILED DESCRIPTION

In some implementations of the disclosed technology, a bunched order system and/or method can create a bunched order with sub allocation accounts inside a single block order message in conjunction with quantity symbol, side, price, and type. The system can further run a pre-risk check on each individual sub-account listed within the single bunched order message, omitting those sub-accounts that do not possess the required minimum capital to clear order. Sub-accounts may belong to clearing brokers outside of the executing broker who is initiating the trade, as in a give-up method. Currently, there is no tool in any financial market capable of running pre-risk checks on block orders between clearing and executing brokers.

Some implementations of the disclosed technology will be described more fully hereinafter with reference to the accompanying drawings. This disclosed technology may, however, be embodied in many different forms and should not be construed as limited to the implementations set forth herein.

In the following description, numerous specific details are set forth. It is to be understood, however, that implementations of the disclosed technology may be practiced without these specific details. In other instances, well-known methods, structures and techniques have not been shown in detail in order not to obscure an understanding of this description. References to “one implementation,” “an implementation,” “example implementation,” “various implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Although certain embodiments of the disclosure are explained in detail, it is to be understood that other embodiments are contemplated. Accordingly, it is not intended that the disclosure is limited in its scope to the details of construction and arrangement of components set forth in the following description or illustrated in the drawings. Other embodiments of the disclosure are capable of being practiced or carried out in various ways. Also, in describing the embodiments, specific terminology will be resorted to for the sake of clarity. It is intended that each term contemplates its broadest meaning as understood by those skilled in the art and includes all technical equivalents which operate in a similar manner to accomplish a similar purpose.

The components described hereinafter as making up various elements of the disclosure are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter.

Embodiments of the present disclosure can provide a bunched order technology platform to allow individual trading accounts to be run through pre-trade risk checks while being sent to an exchange from a single bunched order. Among other applications, money managers may use bunched orders to place large orders on behalf of multiple client sub-accounts in a single order. Currently, brokers and money managers using block orders are breaking existing laws and violating regulations innumerable times each day since every trading account that is being traded in a block order is required by the NFA to be run through pre-trade risk checks to confirm the account has enough margin (among other risk checks). As noted, at this time there is no technology to provide this solution.

In addition to the regulatory requirement, the missing check creates a massive liability and large risk for the brokers who support money managers and other applications using block orders. The present disclosure can provide the technology to solve this systemic industry problem. Outlined below are a few specific areas the presently disclosed technology can address and an overview of how certain embodiments work.

Embodiments of the present disclosure can provide a system and/or method for bunched order processing. In some embodiments, a brokerage system can create and/or connect a lead trader's messenger account through an order router's back office. The messenger account can be an account connected to a trading platform where the trader can place the actual buying and selling transactions. In some embodiments, the account can be synthetically funded. As would be readily appreciated, the purpose of this messenger account is to send the message of the orders to the system.

It should be understood that the mention of one or more method steps does not preclude the presence of additional method steps or intervening method steps between those steps expressly identified. Moreover, although the term “step” may be used herein to connote different aspects of methods employed, the term should not be interpreted as implying any particular order among or between various steps herein disclosed unless and except when the order of individual steps is explicitly required.

Embodiments of the present disclosure can provide an improved method for bunched order processing, the steps of which are outlined below. As a first step, a brokerage can create and/or connect a sub-account (or client trading account) to the system through an order router's back office. Subsequently, via the system, a lead trader account can connect the sub-account to a specific trading strategy. At this point, the sub-account may now be tied to the lead trader account. The lead trader account can then define one or more allocation parameters for the sub-account on each contract/symbol that they (i.e., the lead trader and the sub-account) will trade. For example, the one or more allocation parameters can comprise: one contract when trading ENQ (E-mini Nasdaq), and two contracts when trading YM (E-mini Dow). In some embodiments, the brokerage or money manager may have the ability to adjust this pre-set allocation at any time.

In some embodiments, after defining the allocation parameters, the lead trader account can place a trade. For instance, the lead trader account can buy one share. After the trade is placed, the system can receive a message or indication of a trade. In some embodiments, the system can review, in a related database, one or more client accounts comprising the sub-accounts connected to lead trader account. The system can then create a new bunched order with the one or more sub-accounts connected to the lead trader, or messenger, account and set the number of contracts based on the pre-set allocation settings made by the lead trader account for each of the one or more sub-accounts. Subsequently, the system can send the bunched order (with pre-set allocations for each sub-account) to the order router. It is to be understood that the lead trader account can also have an associated sub-account for making trades. In such a manner, when filling a bunched order, the lead trader account can be filled through the corresponding sub-account when the plurality of sub-accounts is filled.

In some embodiments, the order router can perform a pre-trade risk assessment on each individual sub-account. In some embodiments, when an account from the one or more sub-accounts does not pass the pre-trade risk assessment, the order router can reject individual sub-accounts from the one or more sub-accounts and automatically adjust allocation for the bunched order and then the bunched order can then be sent to an exchange to be filled.

The system can then receive a notification of fills. In some embodiments, the system can create a final fill price based off the exchange fill prices and the predetermined pricing structure (APS, etc.). In some embodiments, the system can transfer the filled orders from the executing broker to the clearing broker in real-time. Additionally, the system can share the transaction data with executing and clearing brokers, in real time, adding visibility to real-time risk exposure for all parties involved in the trade that is unavailable using conventional block orders because the only visibility is into the total price and quantity of the block order without the itemization provided by the bunched order.

As will be appreciated, the disclosed systems and methods can allow brokers to create pre-determined allocation settings, run individual sub-accounts through pre-trade risk in bunched orders, receive real-time allocations for bunched orders and give-up orders, and drastically reduce risk of give-up orders and in-house bunched orders.

### Terms

The following terms are provided for example and not limitation, and whether capitalized throughout or not, such terms should be afforded the following meanings:

Order Router: technology for connecting and exchanging financial trading messages between exchanges, banks, brokerages, and third-party platform providers.

Order Router Messenger FIX Server (ORMFS): technology for passing messenger trade details between a lead trader's trading platform or a clearing broker and an Order Router FIX Client.

Bunched Order Messenger FIX Server (BOMFS): technology for passing messenger trade details between an Order Router FIX Client and a Bunched Order Trading Core.

Bunched Order Trading Core (BOTC): technology for generating, managing, and handling bunch order trading messages between a Bunched Order Messenger FIX Server and a Bunched Order FIX Client.

Bunched Order FIX Client (BOFC): technology for managing and handling trade orders between an Order Router FIX Server and a Bunched Order Trading Core.

Order Router FIX Client (ORFC): technology for managing and handling trade orders between and Order Router Messenger FIX Server and a Bunched Order Messenger FIX Server.

Order Router FIX Server (ORFS): technology for managing and handling trade orders between the Bunched Order FIX Client and the connected clients and exchanges/clearing firms.

Bunched Order: converted block order within the order message that includes the individual account numbers and corresponding trade details that what each account is responsible for in the original block order (also referred to as “Bunched Block Order”).

Bunched Order User Interface (BOUI): an interface provided to users of the systems and methods disclosed herein where users can view information relating to trades and accounts, other displays, and receive notifications and communications from the system and/or other accounts.

Executed Order: place order that has been filled and completed. As a non-limiting example, if a trader places a new order to buy 100 shares of Stock X, and a seller completes the transaction by selling the trader 100 shares of Stock X, then the trade has been executed/filled/completed.

Block Order: industry-standard single large trade order that does not specify individual account numbers and corresponding trade details specifying what each real account is responsible for.

Sub-Account: actual trading accounts for lead traders and/or investors.

Pre-Trade Allocation: bunched order that has been sent for execution but is yet to be risk analyzed.

Risk Analysis: a process of verifying that each individual account in a bunched order possess enough capital required to place an order for the respective accounts' responsibilities in the bunched order. Real accounts that do not possess enough required capital are rejected from the bunched order. Real accounts that do possess enough required capital are permitted to execute.

Post-Trade Allocation: risk-analyzed bunch order wherein each individual account remaining in the bunch order passed risk analysis, and the order was filled.

FIX Protocol: an open electronic communications protocol designed to standardize and streamline electronic communications in the financial services industry supporting multiple formats and types of communications between financial entities including trade allocation, order submissions, order changes, execution reporting and advertisements.

Executing Broker: broker where a lead trader's accounts and funds reside and from where a lead trader's orders are placed.

Clearing Broker: broker where a sub-account and related funds reside and that allow Executing Brokers to execute trades on behalf of the sub-accounts; can also be an Executing Broker if lead trader account and sub-account co-reside. The Give Up Broker: executing broker who executes trades belonging to sub-accounts outside of its own brokerage firm.

Give In Broker: clearing broker that controls sub-accounts and is responsible for taking filled orders from outside Executing Brokers.

Give Up Order: block or bunch order executed by an Executing/Give Up Broker on behalf of sub-accounts residing at other broker firms (i.e., Clearing/Give In Brokers).

Collection Account: An account used to send a bunched order to an exchange to be filled. Each sub account can be associated with the Collection Account. All sub account orders can be sent to the exchange via the Collection Account.

Example implementations of the disclosed technology will now be described with reference to the accompanying figures.

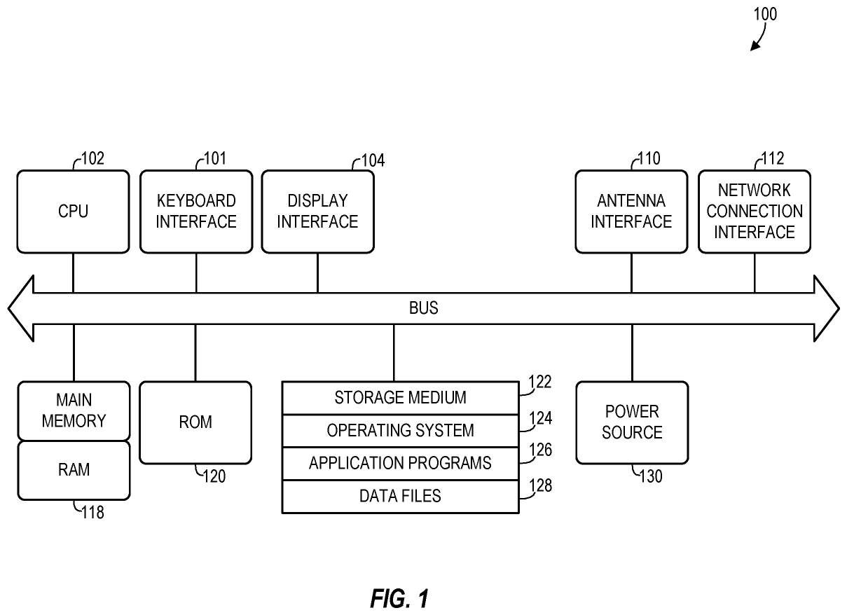

As desired, implementations of the disclosed technology may include a computing device with more or less of the components illustrated in FIG. 1. It will be understood that the computing device architecture 100 is provided for example purposes only and does not limit the scope of the various implementations of the present disclosed systems, methods, and computer-readable mediums.

The computing device architecture 100 of FIG. 1 includes a central processing unit (CPU) 102, where computer instructions are processed; a display interface 104 that acts as a communication interface and provides functions for rendering video, graphics, images, and texts on the display. In certain example implementations of the disclosed technology, the display interface 104 may be directly connected to a local display, such as a touch-screen display associated with a mobile computing device. In certain example implementations, the display interface 104 may wirelessly communicate, for example, via a Wi-Fi channel or other available network connection interface 112 to an external/remote display.

The computing device architecture 100 may include a keyboard interface 106 that provides a communication interface to a keyboard. In one example implementation, the computing device architecture 100 may include a presence-sensitive display interface 108 for connecting to a presence-sensitive display 107. According to certain example implementations of the disclosed technology, the presence-sensitive display interface 108 may provide a communication interface to various devices such as a pointing device, a touch screen, a depth camera, etc. which may or may not be associated with a display.

Example implementations of the computing device architecture 100 may include an antenna interface 110 that provides a communication interface to an antenna; a network connection interface 112 that provides a communication interface to a network. As mentioned above, the display interface 104 may be in communication with the network connection interface 112. According to example implementations, a random access memory (RAM) 118 is provided, where computer instructions and data may be stored in a volatile memory device for processing by the CPU 102.

According to an example implementation, the computing device architecture 100 includes a read-only memory (ROM) 120 where invariant low-level system code or data for basic system functions such as basic input and output (I/O), startup, or reception of keystrokes from a keyboard are stored in a non-volatile memory device. According to an example implementation, the computing device architecture 100 includes a storage medium 122 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 124, application programs 126 (including, for example, a web browser application, a widget or gadget engine, and or other applications, as necessary) and data files 128 are stored. According to an example implementation, the computing device architecture 100 includes a power source 130 that provides an appropriate alternating current (AC) or direct current (DC) to power components.

According to an example implementation, the CPU 102 has appropriate structure to be a computer processor. In one arrangement, the CPU 102 may include more than one processing unit. The RAM 118 interfaces with the computer bus 134 to provide quick RAM storage to the CPU 102 during the execution of software programs such as the operating system application programs, and device drivers. More specifically, the CPU 102 loads computer-executable process steps from the storage medium 122 or other media into a field of the RAM 118 in order to execute software programs. Data may be stored in the RAM 118, where the data may be accessed by the computer CPU 102 during execution.

The storage medium 122 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow a computing device to access computer-executable process steps, application programs and the like, stored on removable and non-removable memory media, to off-load data from the device or to upload data onto the device. A computer program product, such as one utilizing a communication system may be tangibly embodied in storage medium 122, which may comprise a machine-readable storage medium.

According to one example implementation, the term computing device, as used herein, may be a CPU, or conceptualized as a CPU (for example, the CPU 102 of FIG. 1). In this example implementation, the computing device (CPU) may be coupled, connected, and/or in communication with one or more peripheral devices, such as display. In another example implementation, the term computing device, as used herein, may refer to a mobile computing device such as a smartphone, tablet computer, or smart watch. In this example implementation, the computing device may output content to its local display and/or speaker(s). In another example implementation, the computing device may output content to an external display device (e.g., over Wi-Fi) such as a TV or an external computing system.

In example implementations of the disclosed technology, a computing device may include any number of hardware and/or software applications that are executed to facilitate any of the operations. In example implementations, one or more I/O interfaces may facilitate communication between the computing device and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device. The one or more I/O interfaces may be utilized to receive or collect data and/or user instructions from a wide variety of input devices. Received data may be processed by one or more computer processors as desired in various implementations of the disclosed technology and/or stored in one or more memory devices.

One or more network interfaces may facilitate connection of the computing device inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, etc., for communication with external devices and/or systems.

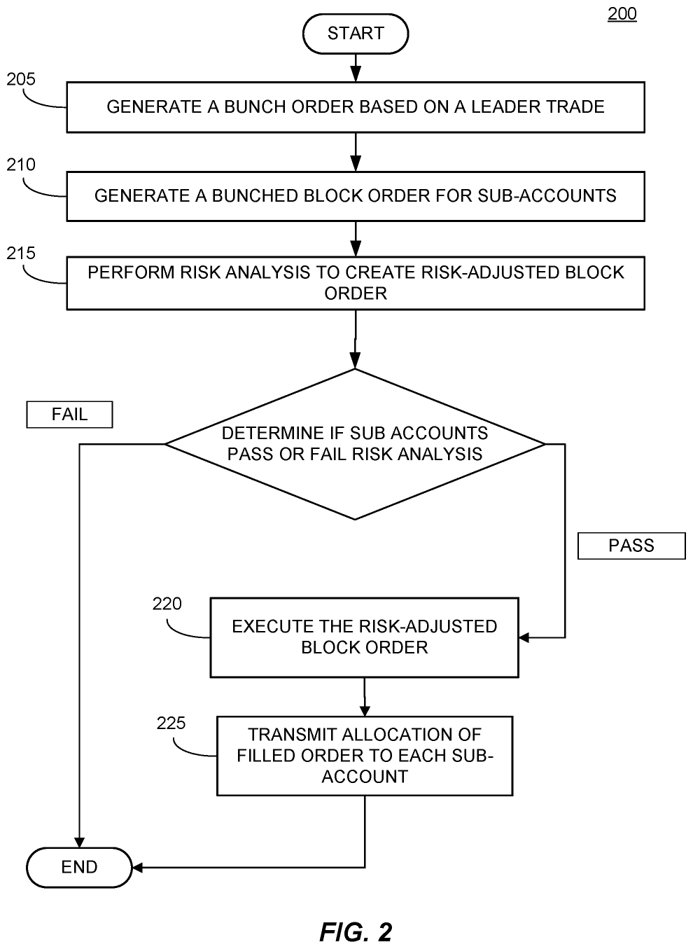

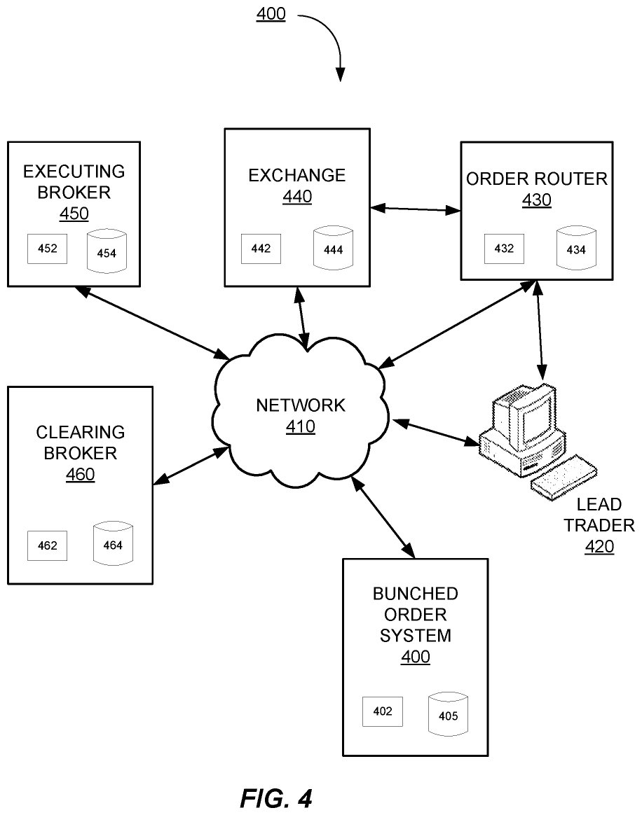

FIG. 2 illustrates a flowchart of a method 200 for executing bunched orders. As shown, a block order can be generated 205 by a bunch order trading core. In some implementations, a block order can be based on information indicative of a leader trade order made by a leader account and received at a bunch order messenger FIX server via an order router messenger FIX server. The leader account can be associated with a lead trader, and the leader account can have data stored in an account database at, for example, an executing broker associated with the order router messenger FIX server. The leader account, and the associated executing broker, can be connected to and in communication with various other components necessary to execute method 200, such as a memory or processor. Other components can be seen, for example, in FIG. 4. The block order can be representative of a trade and/or transaction that the leader account wishes to make. The trade can have a leader price and a leader quantity (e.g., 100 shares of Stock X at a price of $4.20 per share). After generating 205 the block order, method 200 can proceed as shown in FIG. 2, or on to other method steps not shown.

As further shown in FIG. 2, method 200 can include generating 210 a bunched block order (or pre-trade allocation) that includes follower trade orders by, for example, a bunch order trading core. Each follower trade order can be associated with a respective sub-account registered to and/or connected with the leader account. The respective sub-accounts can be connected with the leader account upon passing a risk assessment for each new sub-account. For instance, the bunch order trading core can analyze the amount of capital in each sub-account and compare the amount of capital to the leader account to determine if the sub-account will be able to follow the trades of the leader account. If the sub-account is determined to be fit to connect with the leader account, the sub-account can join the pre-trade allocation.

In some implementations, the follower trade orders can include follower quantities to match the leader quantity (e.g., if the leader buys 100 shares of a stock, the follower buys 100 shares of the same stock). Alternatively, follower quantity can be different than the leader quantity. For example, if the leader buys 100 shares of a stock, the follower can buy a percentage of that amount (e.g., 50% (where the leader buys 100 shares and the follower buys 50 shares) or 150% (where the leader buys 100 shares and the follower buys 150 shares), etc.). The relationship between the follower and the leader can be based upon a previously agreed upon relationship between the follower and leader that specifies amounts the follower will invest based on trades made by the leader (i.e., mimicked trades). The method 200 can then proceed as shown in FIG. 2, or on to other method steps not shown.

Method 200 can further perform risk analysis to determine 215 which accounts (i.e., leader account and sub-accounts) in the bunched order pass a pre-trade risk assessment. In an example implementation, a bunched order messenger FIX server can communicate data indicative of the bunched order to an order router messenger FIX server, and the order router can perform risk analysis on the bunched order. When an account (leader account or sub-account) is deemed to have passed the risk assessment, then that account is added to a bunched order subset of accounts allowed to participate in the bunched block order. This creates a risk-adjusted block order. If, on the other hand, an account is deemed to have failed the risk assessment, then the account and the associated order is discarded or is added to a subset of accounts that are denied from participating in the bunched block order. In some implementations, method 200 can include generating and order rejected message and transmitting the message to accounts that fail the risk assessment, and the rejection message can include the reasons for rejecting the order. As will be appreciated, the risk assessment can include, for example, an analysis of the amount of capital associated with each account to determine if the account has sufficient capital to execute the trade order at the desired quantity and/or price. The amount of capital can include an analysis of margin data. The method 200 can then proceed as shown in FIG. 2, or on to other method steps not shown.

Disclosed systems can then execute 220 the risk-adjusted bunched block order. As will be understood by one of skill in the art, the risk-adjusted bunched block order can be executed over an electronic exchange, which creates a filled order. The filled order can be held in an escrow account to hold financial instruments and/or capital before distributing the filled orders to each of the sub accounts. The filled order data can be transmitted from the exchange to the order router, and the order router can notify the bunched order trading core that the orders have been filled. The bunched order trading core can then determine a specific allocation of the filled order to be distributed to the various sub-accounts. The allocation can be determined from the follower and/or the leader quantities. The method 200 can then proceed to block 225, or on to other method steps not shown.

In block 225, the method 200 can transmit an allocation of the filled order to each sub account participating in the risk-adjusted bunched block order. In such a manner, the trades placed by each of the sub accounts can be realized. For example, if the bunched block order is to purchase shares of a stock, funds can be withdrawn from the sub accounts to the collection account to realize the trade. Alternatively, or additionally, if the bunched block order is to sell shares of a stock, funds can be deposited into the sub accounts from the collection account to realize the trade. Additionally, a filled order message can be transmitted to each participating sub account through a trade order interface. The method 200 can then terminate after block 225. However, the method 200 can also continue on to other method steps not shown.

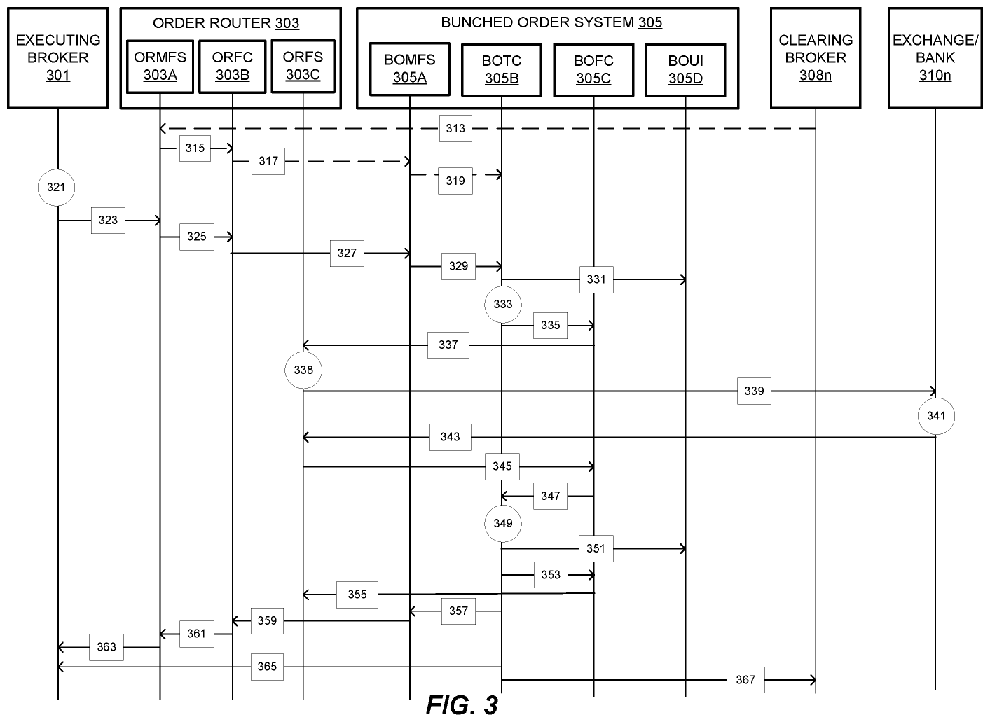

FIG. 3 is a timing diagram for executing bunched block orders. The illustrated timing diagram can be implemented by any of the various components, systems, and/or devices disclosed herein. As shown, an order router message FIX server 303A may optionally receive 313 one or more sub-account connections from a clearing broker 308n. Data can also be transmitted to the order router message FIX server 303A relating to the one or more sub-accounts. The one or more sub-accounts can be linked to multiple different clearing brokers, or one ubiquitous clearing broker. The sub-accounts can be investors or traders who wish to link their trades and/or accounts to a trustworthy leader account. The sub-account data can then be transmitted 315 from the order router message FIX server 303A to the order router FIX client 303B. The order router FIX client 303B can then transmit 317 the sub-account data to an associated bunched order system 305 through a bunched order message FIX server 305A. The bunched order system can then transfer 319 the sub-account data to the associated bunched order trading core 305B.

A leader account can generate 321 a leader trade at an executing broker 301. The executing broker 301 and the clearing broker 308n can be the same broker, or different brokers. The executing broker 301 can also gather data on the leader account similar to the data gathered for the sub-accounts. The order router 303 receives 323 the leader trade and associated data for the leader account from the executing broker 301 through the order router message FIX server. The leader trade and related account data is then transferred 325 from the order router message FIX server 303A to the order router FIX client 303B. The order router FIX client 303B can then transmit 327 the sub-account data to an associated bunched order system 305 through a bunched order message FIX server 305A. The bunched order system can then transfer 329 the sub-account data to the associated bunched order trading core 305B.

When the leader trade is received 329 by the bunched order trading core 305B, the bunched order trading core 305B can transmit 331 a notification and/or alert (or other form of communication) to a bunched order user interface 305D. In such a manner, the leader account and/or the other associated sub-accounts can be notified that a trade has been made. The leader trade data can also be displayed to the users of the sub-accounts. Other actions can then be taken, such as having each of the sub-accounts review the trade or having each of the sub-accounts input a desired quantity or amount to participate in the leader trade. The bunched order trading core 305B can then generate 333 a bunched order for the leader account and each of the associated sub-accounts that wish to participate. The bunched order is transferred 335 to the bunched order FIX client 305C to be transmitted 337 to the order router FIX server 303C.

The order router 303 can then perform a risk-analysis on the bunched order to determine 338 which accounts (i.e., leader account and sub-accounts) in the bunched order pass a pre-trade risk assessment. When an account (leader account or sub-account) is deemed to have passed the risk assessment, then that account is added to a bunched order subset of accounts allowed to participate in a bunched block order. This creates a risk-adjusted block order. If, on the other hand, an account is deemed to have failed the risk assessment, then the account and the associated order is discarded or is added to a subset of accounts that are denied from participating in the bunched block order. As will be appreciated, the risk assessment can include, for example, an analysis of the amount of capital associated with each account to determine if the account has sufficient capital to execute the trade order at the desired quantity and/or price. The amount of capital can include an analysis of margin data.

The risk-adjusted bunched block order is then transmitted 339 to an exchange or bank 310n to be executed and filled. The exchange or bank 310n can be filled 341 as a block order. As would be appreciated by those of ordinary skill in the art, the exchange 310n filling the order as a block order greatly improves efficiency of the trade and reduces risks associated with the trade while remaining agnostic to the specific distribution of the trade to each of the sub-accounts. The filled order is then transmitted 343 to the order router 303 through the order router FIX server 303C to establish data indicating that the trade order has been filled. The filled order data is then transmitted 345 to the bunched order system 305 through the bunched order FIX client 305C. The filled order data is then transferred to the bunched order trading core 305B.

The bunched order trading core 305B can then resolve 349 the filled order to determine the specific amounts and allocations of the filled order to be assigned to each of the sub-accounts. In such a manner, the bunched order trading core 305B can create a resolved ledger, or another form of post-allocation file (such as a table, a spreadsheet, and the like). The resolved ledger can have each of the participating sub-accounts and their respective allocations held within. Once the allocation is determined, the bunched order trading core 305B can transmit 351 a notification and/or alert (or other form of communication) to a bunched order user interface 305D. In such a manner, the leader account and/or the other associated sub-accounts can be notified that the trade has been executed and that the order has been filled. The allocation and/or resolved order data can also be displayed to the users associated with the sub-accounts through the bunched order user interface 305D. For example, the resolved order data can be placed in a ledger corresponding to each of the sub-accounts and their respective allocations.

The allocation and/or resolved order can also be transferred 353 to the bunched order FIX client 305C to be transmitted to the order router FIX server 303C. The allocation and/or resolved order can also be transferred 357 to the bunched order message FIX server 305A and then transmitted 359 to the order router 303 through the order router FIX client 303B. The allocation is then transferred to the order router message FIX server 303A to be transmitted to the lead account at the executing broker 301. The bunched order trading core 305B can also directly transmit 365 the resolved order and/or allocation to the executing broker 301, and/or the bunched order trading core 305B can directly transmit 367 the resolved order and/or allocation to the clearing broker 308n.

FIG. 4 illustrates another example system 400 for executing bunched orders. The system 400 can be in communication with more or less of the components shown in FIG. 4. It will be understood that the system 400 is provided for example purposes only and does not limit the scope of the various implementations of the present disclosed systems, methods, and computer-readable mediums. As shown, each of the components of the system 400 can include a processor and/or a storage device, such as memory. For example, the clearing broker 460 can include a processor 462 and a storage device 464. The various components of the system 400 can also include the components of the computing devices 100 as described in FIG. 1, and the components of the system 400 can be interconnected via a network 410.

As shown, the system 400 can include an account database 405 that can store data and communicate with one or more accounts. The accounts can include, for example, a messenger and/or a leader account, a collection account, and/or a sub-account. The data stored in the account database 405 can include, for instance, historical trade data (e.g., quantities and prices of stock purchased, how long securities were held, amount of capital, margin data, and the like). The account database 405 can also be an external database. For example, a sub-account can have data stored with an external broker in a database that communicates with the system 400 through the network 405.

Additionally, the system 400 can communicate with a lead trader 420 and/or a messenger account associated with the lead trader 420. The lead trader 420 can have a messenger account with, for instance, an executing broker 450 and/or a clearing broker 460. In some implementations, the executing broker 450 and the clearing broker 460 can be one broker. In other implementations, the executing broker 450 and the clearing broker 460 can be different brokers. The orders placed by the lead trader at the executing broker 450 and/or the clearing broker 460 and other components of the system can be placed through an order router 430.

The order router 430 can receive and transmit orders to and from the bunched order system 400. For example, the order router 430 can transmit a leader trade order from the lead trader 420. The order router 430 can also receive a block bunched order from the bunched order system 400 to be executed on an exchange 440. The exchange 440 can be any entity capable of exchanging equity, securities, and/or other financial instruments to fill orders, such as the leader trade order. The exchange 440 can receive the block bunched order from the order router 430 and fill the order. Then, the order router 430 can notify the bunched order system 400 that the order has been filled.

The order router 430 can also be capable of performing a pre-trade risk assessment on each of the sub-accounts in a bunched order. This can ensure that the block bunched order can go through the exchange 440 smoothly. If any sub-account is unable to participate in the bunched order, then the sub-account is excluded from the block bunched order. The order router 430 can then block the order together in a single block.

Additionally, the bunched order system 400 can receive the filled order from the order router 430 and begin to allocate the order to sub-accounts associated with the executing broker 450 and/or the clearing broker 460.

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented or may not necessarily need to be performed at all, according to some implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

Implementations of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person of ordinary skill to practice certain implementations of the disclosed technology, including making and using any devices or systems and performing any incorporated methods. The patentable scope of certain implementations of the disclosed technology is defined in the claims and may include other examples that occur to those of ordinary skill. Such other examples are intended to be within the scope of the claims if they have structural elements that do not differ from the literal language of the claims, or if they include equivalent structural elements with insubstantial differences from the literal language of the claims.

1. A method comprising:
receiving, at a bunched order messenger FIX server and from an order router FIX client, data indicative of user accounts comprising at least user information and user fund information;
transmitting, from the bunched order messenger FIX server and to a bunched order trading core, the data indicative of user accounts;
receiving, at the bunched order messenger FIX server and from the order router FIX client, data indicative of a leader trade, the data indicative of the leader trade comprising (i) an instruction to buy or sell, (ii) a symbol, (iii) a quantity, and (iv) a price;
transmitting, from the bunched order messenger FIX server and to the bunched order trading core, the data indicative of the leader trade;
responsive to receiving the data indicative of the leader trade, (i) transmitting, by the bunched order trading core and for display at a bunched order user interface, data indicative of the leader trade and (ii) generating a bunched order, the bunched order comprising (a) the information indicative of the leader trade and (b) information indicative of a sub-account trade, the sub-account associated with a user account, and the information indicative of the sub-account trade comprising (i) an instruction to buy or sell that matches the instruction to buy or sell in the data indicative of the leader trade, (ii) the symbol, (iii) a quantity based at least in part on the quantity in the data indicative of the leader trade, and (iv) the price;
transmitting, by the bunched order trading core and to a bunched order FIX client, the bunched order;
transmitting, from the bunched order FIX client and to an order router FIX server, the bunched order for (i) risk assessment and (ii) trade execution;
receiving, at the bunched order FIX client and from the order router FIX server, data confirming fulfillment of an order associated with the bunched order, wherein the data confirming fulfillment of an order associated with the bunched order comprises (i) the symbol, (ii) a quantity, and (iii) a price;
transmitting, from the bunched order FIX client and to the bunched order trading core, the data confirming fulfillment of an order associated with the bunched order;
resolving, by the bunched order trading core and based on the data confirming fulfillment of an order associated with the bunched order, the bunched order, wherein resolving the bunched order comprises (i) determining a quantity and a price attributable to the leader trade and a quantity and a price attributable to the sub-account trade and (ii) generating a resolved ledger that comprises the quantity and the price attributable to the leader trade and the quantity and the price attributable to the sub-account trade;
transmitting, by the bunched order trading core and for display at the bunched order user interface, data indicative of the resolved ledger;
transmitting, by the bunched order trading core and to (i) an executing broker and (ii) a clearing broker, the data indicative of the resolved ledger;
transmitting, from the bunched order trading core and to the bunched order FIX client, the data indicative of the resolved ledger;
transmitting, from the bunched order FIX client and to the order router FIX server, the data indicative of the resolved ledger;
transmitting, from the bunched order trading core and to the bunched order messenger FIX server, the data indicative of the resolved ledger; and
transmitting, from the bunched order messenger FIX server and to the order router FIX client, the data indicative of the resolved ledger.

2. A method comprising:
receiving, at a bunched order system, and from an order router, data indicative of user accounts comprising at least user information and user fund information;
receiving, at the bunched order system and from the order router, data indicative of a leader trade;
responsive to receiving the data indicative of the leader trade, (i) outputting, by the bunched order system and for display at an associated user interface, data indicative of the leader trade and (ii) generating a bunched order;
transmitting, by the bunched order system and to the order router, the bunched order for (i) risk assessment and (ii) trade execution by the order router;
receiving, at the bunched order system and from the order router, data confirming fulfillment of an order associated with the bunched order;
resolving, by the bunched order system and based on the data confirming fulfillment of an order associated with the bunched order, the bunched order.

3. The method of claim 2, wherein the data indicative of the leader trade comprises (i) an instruction to buy or sell, (ii) a symbol, (iii) a quantity, and (iv) a price.

4. The method of claim 3, wherein the bunched order comprises (a) the information indicative of the leader trade and (b) information indicative of a sub-account trade, the sub-account associated with a user account.

5. The method of claim 4, wherein the information indicative of the sub-account trade comprises (i) an instruction to buy or sell that matches the instruction to buy or sell in the data indicative of the leader trade, (ii) the symbol, (iii) a quantity based at least in part on the quantity in the data indicative of the leader trade, and (iv) the price.

6. The method of claim 3, wherein the data confirming fulfillment of an order associated with the bunched order comprises (i) the symbol, (ii) a quantity, and (iii) a price.

7. The method of claim 6, wherein resolving the bunched order comprises (i) determining, based at least in part on the data confirming fulfillment of the order associated with the bunched order, a quantity and a price attributable to the leader trade and a quantity and a price attributable to the sub-account trade.

8. The method of claim 7, wherein resolving the bunched order further comprises generating a resolved ledger that comprises the quantity and the price attributable to the leader trade and the quantity and the price attributable to the sub-account trade.

9. The method of claim 8 further comprising, responsive to generating the resolved ledger, (i) outputting, by the bunched order system and for display at the user interface, data indicative of the resolved ledger, (ii) transmitting, by the bunched order system and to (a) an executing broker and/or (b) a clearing broker, the data indicative of the resolved ledger, and (iii) transmitting, from the bunched order system and to the order router, the data indicative of the resolved ledger.

10. The method of claim 8 further comprising, responsive to generating the resolved ledger, outputting, by the bunched order system and for display at the user interface, data indicative of the resolved ledger.

11. The method of claim 8 further comprising, responsive to generating the resolved ledger, transmitting, by the bunched order system and to (i) an executing broker and/or (ii) a clearing broker, the data indicative of the resolved ledger.

12. The method of claim 8 further comprising, responsive to generating the resolved ledger, transmitting, from the bunched order system and to the order router, the data indicative of the resolved ledger.

13. The method of claim 13 further comprising:
evaluating, using the user information and the user fund information, each of the user accounts; and
determining whether the user accounts meets predetermined risk criteria to participate in the leader trade.

14. A method comprising:
receiving, at an order router, and from a clearing broker, data indicative of user accounts comprising at least user information and user fund information, and from an executing broker, data indicative of a leader trade;
transmitting, from the order router and to a bunched order system, (i) the data indicative of user accounts and (ii) data indicative of the leader trade;
responsive to receiving the data indicative of the leader trade, (i) outputting, by the bunched order system and for display at an associated user interface, data indicative of the leader trade and (ii) generating a bunched order;
transmitting, by the bunched order system and to the order router, the bunched order;
responsive to receipt of the bunched order, (i) performing, by the order router, risk assessment of the bunched order and (ii) outputting, by the order router and to an exchange or bank, for trade execution by the exchange or bank, the bunched order;
receiving, at the order router, data confirming fulfillment of an order associated with the bunched order;
transmitting, from the order router and to the bunched order system, the data confirming fulfillment of the order associated with the bunched order;
resolving, by the bunched order system and based on the data confirming fulfillment of an order associated with the bunched order, the bunched order.

15. The method of claim 14, wherein the data indicative of the leader trade comprises (i) an instruction to buy or sell, (ii) a symbol, (iii) a quantity, and (iv) a leader trade price and wherein the data confirming fulfillment of an order associated with the bunched order comprises (i) the symbol, (ii) a quantity, and (iii) a fulfillment price.

16. The method of claim 15, wherein resolving the bunched order comprises (i) determining, based at least in part on the data confirming fulfillment of the order associated with the bunched order, a quantity and a price attributable to the leader trade and a quantity and a price attributable to each sub-account trade.

17. The method of claim 16, wherein resolving the bunched order further comprises generating a resolved ledger that comprises the quantity and the price attributable to the leader trade and the quantity and the price attributable to the sub-account trade.

18. The method of claim 17 further comprising, responsive to generating the resolved ledger, (i) outputting, by the bunched order system and for display at the user interface, data indicative of the resolved ledger, (ii) transmitting, by the bunched order system and to (a) the executing broker and/or (b) the clearing broker, the data indicative of the resolved ledger, and (iii) transmitting, from the bunched order system and to the order router, the data indicative of the resolved ledger.

19. The method of claim 18 further comprising, responsive to receipt of the data indicative of the resolved ledger at the order router, transmitting, from the order router and to the executing broker, the data indicative of the resolved ledger.
